(19) United States
(12) Patent Application Publication
(10) Pub. No.: US 2018/0217314 A1
(43) Pub. Date: Aug. 2, 2018

(54) BACKLIGHT MODULE, METHOD FOR ASSEMBLING THE SAME AND DISPLAY DEVICE

(71) Applicants: BOE TECHNOLOGY GROUP CO., LTD., Beijing (CN); BOE OPTICAL SCIENCE AND TECHNOLOGY CO., LTD., Suzhou, Jiangsu (CN)

(72) Inventors: Xiaozeng PEI, Beijing (CN); Guangyue HU, Beijing (CN)

(21) Appl. No.: 15/325,311

(22) PCT Filed: Jul. 22, 2016
(86) PCT No.: PCT/CN2016/091039

§ 371 Date: Jan. 10, 2017

(30) Foreign Application Priority Data
Oct. 21, 2015 (CN) 201520820142.2

(51) Int. Cl. F21V 8/00

(52) U.S. Cl. CPC G02B 6/0051; G02B 6/0055; G02B 6/0053; G02B 6/0088; G02B 6/0065

(57) ABSTRACT

A backlight module, a method for assembling the same and a display device are disclosed. The backlight module includes an optical film (11) and a light-shielding tape (12), wherein the light-shielding tape (12) is disposed on n sides of all four sides of the optical film (11), n being a positive integer smaller than 4. By reducing an area of regions covered by the light-shielding tape (12) on the optical film (11) of the backlight module, an area of the viewing region of the backlight module is increased.

### FIELD OF THE ART

Embodiments of the disclosure relate to the technical field of displays, more particularly, to a backlight module, a method for assembling the same and a display device.

### BACKGROUND

A backlight module is a light source fixed to the back of a Liquid Crystal Display (LCD). The luminous effect of the backlight module will directly influence the visual effect of the LCD. A viewing area-on-screen ratio of a backlight module is a crucial factor for evaluating the quality of the backlight module. The “viewing area-on-screen ratio” as used herein refers to a ratio between the viewing area of the backlight module to an overall area of the backlight module.

A known backlight module comprises a light source, a light guide plate (LGP), an optical film, a light-shielding tape, a back plate and a mould frame. The light-shielding tape is attached to a periphery of the optical film and configured for fixing the backlight module and the LCD. An area within a central area of the homocentric squares (one square encircled by another bigger one) formed by the light-shielding tape of the backlight module on the optical film constitutes the viewing area of the backlight module.

### SUMMARY

In one aspect of the disclosure, a backlight module is provided. The backlight module comprises an optical film and a light-shielding tape, wherein the light-shielding tape is disposed on n sides of all four sides of the optical film, wherein n is a positive integer smaller than 4.

In another aspect of the disclosure, a display device comprising the above backlight module is provided.

In still another aspect of the disclosure, a method for assembling a backlight module is provided. The method comprises providing an optical film; and disposing a light-shielding tape at n sides of all four sides of the optical film, wherein n is a positive integer smaller than 4.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 schematically illustrates a backlight module in accordance with an embodiment of the disclosure;

FIG. 2 schematically illustrates a cross section of a backlight module in accordance with an embodiment of the disclosure;

FIG. 3 schematically illustrates a cross section of another backlight module in accordance with an embodiment of the disclosure; and

FIG. 4 illustrates a flow chart of a method of assembling a backlight module in accordance with an embodiment of the disclosure.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

An embodiment of the disclosure provides a backlight module. With reference to FIG. 1, the backlight module comprises an optical film 11 and a light-shielding tape 12; the light-shielding tape 12 is disposed on n sides of all four sides of the optical film 11, where n is a positive integer smaller than 4, such as 1, 2 or 3. The backlight module further comprises a mould frame 10, the optical film 11 is adhered to the mould frame 10 by way of the light-shielding tape 12. As an example, in the backlight module illustrated in FIG. 1, n is equal to 1, that is, one of the four sides of the optical film 11 has the light-shielding tape 12 disposed thereon.

In the above backlight module, as at least one side of the four sides of the optical film has the light-shielding tape disposed thereon, an area of the optical film covered by the light-shielding tape is reduced, thereby increasing an area of the viewing area of the backlight module, which further increases the viewing area-on-screen ratio of the backlight module.

Moreover, the light-shielding tape 12 is disposed on any side of the four sides of the optical film 11, that is, n is equal to 1, which can effectively reduce the area of the optical film 11 covered by the light-shielding tape 12, and further increases the viewing area-on-screen ratio of the backlight module. In at least some of the embodiments, the light-shielding tape 12 overlays a part of any side of the optical film 11. For example, the light-shielding tape 12 is non-continuously adhered to any side of the optical film 11.

In real applications, the light-shielding tape 12 may be disposed at different positions according to actual conditions of products. As an example, for a backlight module of a mobile phone, as microphones, speakers and similar components are typically disposed at the upper and lower edges of the mobile phone screen, it may dispose the light-shielding tape 12 at any edge of the optical film which corresponds to the upper or lower edge of the mobile phone screen. As an example illustrated in FIG. 1, the light-shielding tape 12 may be disposed on one of the two shorter sides of the four sides of the optical film 11.

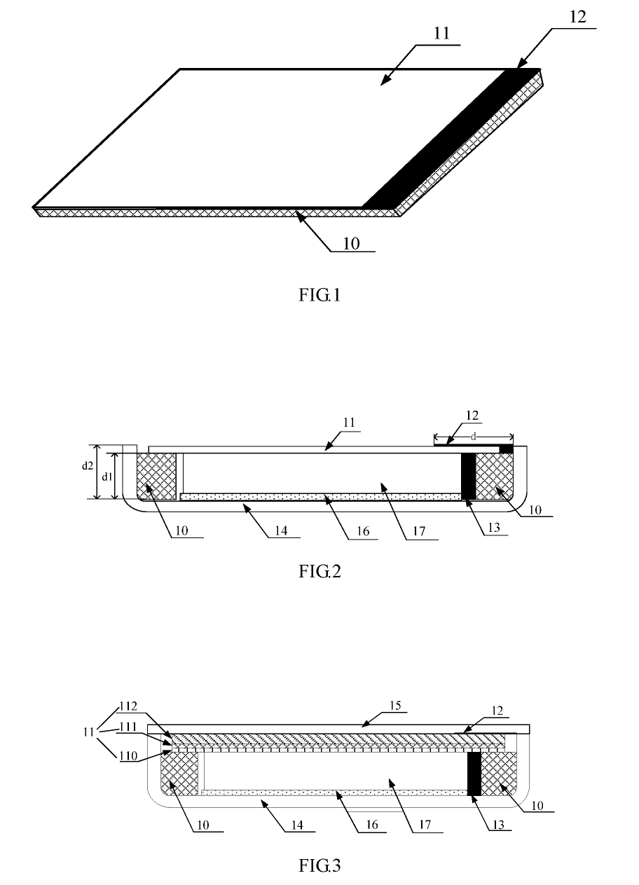

FIG. 2 schematically illustrates a cross section of a backlight module in accordance with an embodiment of the disclosure. As illustrated in FIG. 2, the backlight module further comprises a light source 13. The light source 13 is disposed at an end inside the mould frame 10. The light-shielding tape 12 is disposed on one of four sides of the optical film 11 which is close to the light source 13. That is to say, the light source 13 is disposed inside the mould frame 10 and close to the side having the light-shielding tape 12. The light-shielding tape 12 is adhered to a surface of the optical film 11. The light-shielding tape 12 is for example a strip-shped tape, and a width d of the light-shielding tape 12 is for example about 5 mm. The light-shielding tape 12 being disposed on one of four sides of the optical film 11 and close to the light source 13 can not only fix the optical film 11 to the mould frame 10 but also shield light. For example, the light source 13 is an edge-lit light source. In this case, the light of the light source 13 can be prevented from upwardly exiting from the optical film 11 by the light-shielding tape 12.

In at least some of the embodiments, as illustrated in FIG. 2, the backlight module further comprises a back plate 14, the back plate 14 is a case. The mould frame 10 is disposed inside the back plate 14, and a thickness d1 of the mould frame 10 is smaller than a thickness d2 of the back plate 14. As an example, in a real application, the back plate 14 and the mould frame 10 may be integrally formed by way of In-Mold Decoration (IMD). It can be seen from the cross section of FIG. 2 that the thickness d2 of the sidewall at the periphery of the back plate 14 is larger than the thickness dl of the mould frame. In this case, when the backlight module is being assembled, the sidewall at the periphery of the back plate 14 may be used to limit the position of the optical film 11 on the mould frame 10, thereby improving the disposition speed and disposition accuracy of the optical film 11.

FIG. 3 schematically illustrates a cross section of another backlight module in accordance with an embodiment of the disclosure. As illustrated in FIG. 3, the backlight module further comprises a removable release film 15. The release film 15 covers the optical film 11 and is fixed to the back plate 14.

The release film 15 may be used to fix the optical film 11. The release film 15 may be a light-shielding tape release film. The light-shielding tape release film 15 has slight adhesiveness with the light-shielding tape and can thereby be removed easily. When the backlight module is assembled with a display panel, the release film 15 may be removed, then the light-shielding tape 12 together with invisible glue coated around the back plate 14 may be used to assemble and fix the backlight module and the display panel. The removable release film can not only guarantee the effective fixation of the optical film, but also prevent the optical film from being contaminated by external dust and impurities, which helps to guarantee good quality of the backlight module.

In at least some of the embodiments, as illustrated in FIG. 3, the optical film 11 comprises a diffuser plate 110, a lower prism 111 and an upper prism 112 successively stacked on the mould frame 10.

In at least some of the embodiments, as illustrated in FIG. 3, the backlight module further comprises:

a reflective sheet 16 and a light guide plate 17 successively stacked inside the mould frame 10, wherein the optical film 11 is disposed on the mould frame 10 having the light guide plate 17 disposed thereon.

In summary, the above embodiment of the disclosure provides a backlight module, at least one side of the four sides of the optical film thereof has no light-shielding tape disposed thereon, thereby reducing the area of the optical film covered by the light-shielding tape, increasing the area of the viewing area of the backlight module, which further increases the viewing area-on-screen ratio of the backlight module.

An embodiment of the disclosure further provides a display device. The display device comprises the backlight module as illustrated in any one of FIGS. 1 to 3. The display device may be a LCD panel, an e-paper, an OLED panel, a mobile phone, a tablet PC, a television, a display screen, a notebook PC, a digital photoframe, a navigator and any product or component having a display function.

An embodiment of the disclosure further provides a method for assembling a backlight module, comprising:

providing an optical film;

disposing a light-shielding tape at n sides of four sides of the optical film, wherein n is a positive integer smaller than 4.

In the above method for assembling a backlight module, at least one side of all four sides of the optical film thereof has no light-shielding tape disposed thereon, thereby reducing the area of the optical film covered by the light-shielding tape, increasing the area of the viewing area of the backlight module, which further increases the viewing area-on-screen ratio of the backlight module.

In at least some of the embodiments, the step of disposing a light-shielding tape at n sides of four sides of the optical film comprises: adhering the optical film onto a mould frame by way of the light-shielding tape.

In at least some of the embodiments, the step of disposing a light-shielding tape at n sides of all four sides of the optical film comprises: disposing the light-shielding tape on one of the four sides of the optical film.

In at least some of the embodiments, the light-shielding tape overlays a part of the one side of the optical film.

In at least some of the embodiments, the light-shielding tape is adhered to the one side of the optical film non-continuously.

In at least some of the embodiments, the assembling method further comprises: disposing the mould frame inside a back plate, the back plate is a case, and a thickness of the mould frame is smaller than that of the back plate. As an example, the mould frame and the back plate are integrally formed.

In at least some of the embodiments, the assembling method further comprises: overlaying a release film on the optical film and having the same fixed to the back plate.

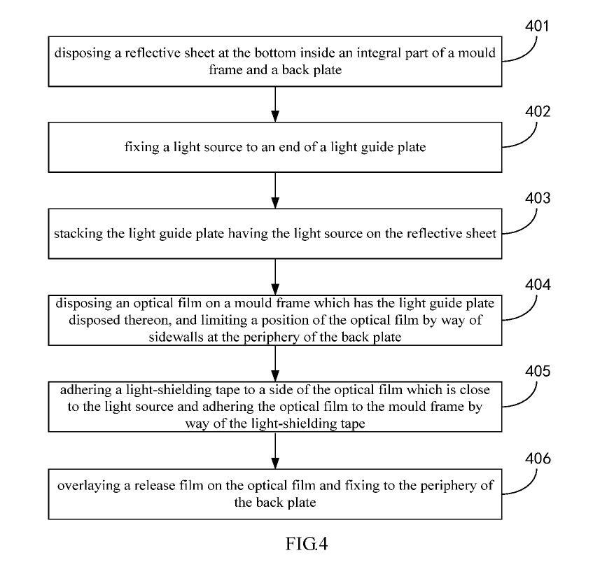

FIG. 4 is a flow chart of a method for assembling a backlight module, such as the backlight module shown in FIG. 3, in accordance with an embodiment of the disclosure. As illustrated in FIG. 4, the assembling method comprises:

Step 401, disposing a reflective sheet 16 at the bottom inside an integral part of a mould frame 10 and a back plate 14.

Step 402, fixing a light source 13 to an end of a light guide plate 17.

Step 403, stacking the light guide plate 17 having the light source 13 on the reflective sheet 16.

Step 404, disposing an optical film 11 on a mould frame 10 which has the light guide plate 17 disposed thereon, and limiting a position of the optical film by way of sidewalls at the periphery of the back plate 14.

As an example, the optical film 11 comprises a diffuser plate 110, a lower prism 111 and an upper prism 112 successively stacked on the mould frame 10.

Step 405, adhering a light-shielding tape 12 to a side of the optical film 11 which is close to the light source 13 and adhering the optical film 11 to the mould frame 10 by way of the light-shielding tape 12.

Step 406, overlaying a release film 15 on the optical film 11 and fixing to the periphery of the back plate 14.

In summary, the method for assembling a backlight module as provided by the embodiment of the disclosure can limit the position of the optical film by using the sidewall at the periphery of the back plate, which improves the assembly efficiency of the backlight module. Moreover, the light-shielding tape is adhered to at least one side of the optical film which is close to the light source, which helps to reduce the area of the optical film covered by the light-shielding tape, effectively increasing the area of the viewing area of the backlight module.

What is described above is related to the illustrative embodiments of the disclosure only and not limitative to the scope of the disclosure; the scopes of the disclosure are defined by the accompanying claims.

The present application claims priority from Chinese Application No. 201520820142.2, filed on Oct. 21, 2015, the disclosure of which is incorporated herein by reference in its entirety.

1. A backlight module, comprising an optical film and a light-shielding tape, wherein the light-shielding tape is disposed on n sides of all four sides of the optical film, wherein n is a positive integer smaller than 4.

2. The backlight module of claim 1, further comprising a mould frame, the optical film being adhered to the mould frame by way of the light-shielding tape.

3. The backlight module of claim 2, wherein one side of the all four sides of the optical film has the light-shielding tape disposed thereon.

4. The backlight module of claim 1, wherein the light-shielding tape overlays a part of one side of the optical film.

5. The backlight module of claim 4, wherein the light-shielding tape is non-continuously adhered to the one side of the optical film.

6. The backlight module of claim 3, further comprising a light source, wherein the light source is disposed on an inner side of the mould frame and close to the one side having the light-shielding tape; and
the light-shielding tape is disposed on the optical film.

7. The backlight module of claim 3, further comprising a back plate, wherein the back plate is a case, the mould frame is disposed inside the back plate, and a thickness of the mould frame is smaller than that of the back plate.

8. The backlight module of claim 7, further comprising a release film, wherein the release film overlays the optical film and is fixed to the back plate.

9. The backlight module of claim 2, wherein the optical film comprises a diffuser plate, a lower prism and an upper prism successively stacked on the mould frame.

10. The backlight module of claim 2, wherein the backlight module further comprises a reflective sheet and a light guide plate successively stacked inside the mould frame, and the optical film is disposed on the mould frame having the light guide plate.

11. The backlight module of claim 1, wherein the light-shielding tape is a strip-shaped tape.

12. The backlight module of claim 1, wherein the light-shielding tape has a width of 5 mm.

13. A display device comprising the backlight module of claim 1.

14. A method for assembling a backlight module, comprising:
providing an optical film;
disposing a light-shielding tape at n sides of all four sides of the optical film, wherein n is a positive integer smaller than 4.

15. The method of claim 14, wherein the step of disposing a light-shielding tape at n sides of all four skies of the optical film comprises: adhering the optical film onto a mould frame by way of the light-shielding tape.

16. The method of claim 14, wherein the step of disposing a light-shielding tape at n skies of all four sides of the optical film comprises: disposing the light-shielding tape on one side of the four sides of the optical film.

17. The method of claim 14, wherein the light-shielding tape overlays a part of the one side of the optical film.

18. The method of claim 17, wherein the light-shielding tape is non-continuously adhered to the one side of the optical film.

19. The method of claim 15, further comprising: disposing the mould frame inside a back plate, the back plate being a case, and a thickness of the mould frame being smaller than that of the back plate.

20. The method of claim 19, further comprising: overlaying a release film on the optical film and having the same fixed to the back plate.
